(19) United States
(12) Patent Application Publication
(10) Pub. No.: US 2014/0318467 A1
(43) Pub. Date: Oct. 30, 2014

(54) ANIMAL CLAW TRIMMING CHAMBER ASSEMBLY

(71) Applicants: Edmond Jette, JR., Sutton, MA (US); Stacey Robinson, Worcester, MA (US); Alison Parvano, Worcester, MA (US); Justin McCarthy, Salem, MA (US); Darwin Keith-Lucas, Arlington, MA (US); Gerard Libby, North Reading, MA (US)

(72) Inventors: Edmond Jette, JR., Sutton, MA (US); Stacey Robinson, Worcester, MA (US); Alison Parvano, Worcester, MA (US); Justin McCarthy, Salem, MA (US); Darwin Keith-Lucas, Arlington, MA (US); Gerard Libby, North Reading, MA (US)

(21) Appl. No.: 14/326,097

(22) Filed: Jul. 8, 2014

Related U.S. Application Data
(63) Continuation of application No. PCT/US2013/020775, filed on Jan. 9, 2013.

(51) Int. Cl. A01K 13/00; A01K 1/035

(52) U.S. Cl. CPC A01K 13/00; A01K 1/035
USPC 119/416

(57) ABSTRACT

A chamber assembly is disclosed for holding an animal securely with minimal stress during claw trimming while providing the user access to the portion of the claw that is to be trimmed. In preferred embodiments, the chamber is adjustable to accommodate different sized animals. In certain embodiments, the chamber can be collapsed for storage or transport.

### CROSS REFERENCE TO RELATED APPLICATIONS

This application is a continuation of and claims benefit of co-pending international patent application PCT/US2013/020775, filed Jan. 9, 2013, and claims the benefit of U.S. Provisional Application Ser. No. 61/584,516, filed Jan. 9, 2012; the contents of both applications are hereby incorporated by reference.

### FIELD OF THE INVENTION

Chambers and tilting bases are disclosed that provide the ability to trim an animal's claws by taking advantage of the animal's natural tendency to climb. In preferred embodiments, the chamber is sized to accommodate a companion animal, such as a cat or bird.

### BACKGROUND OF THE INVENTION

The nails or claws of companion animals grow continuously, and need to be trimmed occasionally to avoid discomfort or injury to the animal. However, holding the animal securely and humanely during the trimming process is a problem, and common methods often pose the likelihood of distress or injury to both the pet and the human doing the trimming

### SUMMARY OF THE INVENTION

A chamber assembly is disclosed for holding an animal securely with minimal stress during claw trimming while providing the user access to the portion of the claw that is to be trimmed. In preferred embodiments, the chamber is adjustable to accommodate different sized animals. In certain embodiments, the chamber can be collapsed for storage or transport.

In certain embodiments, a chamber assembly is provided that comprises a chamber having a first end and a second end opposite to the first end, a first end panel at the first end, a first side panel, a second side panel, and a positioning panel opposite the first end panel; wherein the first side panel is attached to the first end panel and to the positioning panel, and the second side panel is attached to the first end panel and to the positioning panel, and a base having an inner frame attached to a chamber mesh floor, the chamber mesh floor having an upper surface and a lower surface, and an assembly tilt support or a locking hinge. Typically, the chamber assembly also includes an outer frame. In certain embodiments the chamber also includes a top panel.

In certain embodiments, the outer frame and the inner frame of the base are pivotally linked, typically at a corresponding short sides if the frames are rectangular. Preferably the inner frame nests within and is coplanar with the outer frame. In certain embodiments, the outer frame and the inner frame of the base are pivotally linked by hinges.

In preferred embodiments, the top panel is secured to at least one side panel of the chamber by a hinge. In preferred embodiments, the top panel is secured to at least one side panel of the chamber by a latch. In certain embodiments, the chamber is secured to the inner frame by at least one latch. In certain embodiments, the chamber is secured to the outer frame by at least one latch. The inner frame can be pivotally linked to the assembly tilt support, or the outer frame can be pivotally linked to the assembly tilt support. Preferably, the chamber can be folded for transport or storage.

In other embodiments, a method of trimming the claws of an animal is provided that comprises placing the animal in the chamber assembly orienting the animal with its head toward the first end panel of the chamber and with its feet on upper surface of the chamber mesh floor, elevating the first end of the chamber above the second end of the chamber, whereby the animal's claws extend through the openings in the chamber mesh floor below the lower surface of the chamber mesh floor; providing user access to the lower surface of the chamber mesh floor; and removing a portion of the animal's claws that extends below the lower surface of the chamber mesh floor, thereby trimming the animal's claws. In preferred embodiments, the step of providing user access to the lower surface of the chamber mesh floor further includes the step of supporting the first end of the chamber above the second end of the chamber to maintain the chamber mesh floor at a chosen angle with respect to gravity. Generally, the portion of the animal's claws that extends below the lower surface of the chamber mesh floor is removed with a clipper or a grinding wheel. Typically the angle is about 30-75 degrees.

### BRIEF DESCRIPTION OF THE DRAWINGS

The foregoing and other features and advantages will be apparent from the following more particular description of exemplary embodiments of the disclosure, as illustrated in the accompanying drawings, in which like reference characters refer to the same parts throughout the different views. The drawings are not necessarily to scale, emphasis instead being placed upon illustrating the principles of the disclosure.

FIG. 1A shows a side view of an embodiment of a claw trimming chamber assembly 10 comprising a claw trimming chamber 100 and a base 200.

FIG. 1B shows a top view of a base 200 of an embodiment of a claw trimming chamber assembly.

FIG. 1C shows a side view of an embodiment of a claw trimming chamber assembly comprising a folded claw trimming chamber 100 and a base 200.

FIG. 1D shows an embodiment of a claw trimming chamber and base in cross section view at the line A-A of FIG. 1A, showing outer frame 210, inner frame 220, retaining frame 222, chamber mesh floor 250, first side 120, and second side 122.

FIG. 2 shows an end view of the first end 130 of an embodiment of a claw trimming chamber assembly.

FIG. 3 shows a perspective view of an embodiment of a claw trimming chamber assembly 10 in the raised position, showing chamber 100, base 200, first side 120, second side 122, first end 130, guides 140, removable panel 150, outer frame 210, inner frame 220, an assembly tilt support 240, chamber mesh floor 250, and outer frame legs 260. For clarity, top 110, top latches 160, optional base latch 165, chamber junctions 180, chamber hinges 182, and base hinges 230 have been omitted from this drawing.

FIG. 4A is a schematic diagram of a side view of an embodiment of a claw trimming chamber that illustrates common features.

FIG. 4B is a schematic diagram of a side view of an embodiment of a claw trimming chamber assembly in the raised position, where the claw trimming chamber assembly has an outer frame 210, but lacks an assembly tilt support 240.

FIG. 4C is a schematic diagram of a side view of an embodiment of a claw trimming chamber assembly in the raised position, where the claw trimming chamber assembly has an assembly tilt support 240, but lacks an outer frame 210. In certain embodiments, one or more folding braces 246 link the assembly tilt support 240 to the inner frame 210.

FIG. 4D is a perspective view of an embodiment of a claw trimming chamber assembly in the raised position, where the claw trimming chamber assembly has an assembly tilt support 240, but lacks an outer frame 210.

FIG. 5A and FIG. 5B are perspective views of two embodiments of a claw trimming chamber assembly according to FIG. 4A, illustrating connecting the top 110 and positioning panel 150 to the chamber using chamber hinges 182.

FIG. 6A is a schematic diagram of an embodiment in which the claw trimming chamber and the inner frame 220 are produced in a single flat molded structure.

FIG. 6B is a perspective view of an embodiment of a molded structure of FIG. 6A having strengthening ridges 144, and assembled with chamber junctions 180.

FIG. 7A and FIG. 7B are perspective views of an embodiment of a claw trimming chamber according to FIG. 4A having soft side and end panels, and mounted on a base 200 to form a claw trimming chamber assembly.

FIG. 8A is an exploded perspective view of the base of a claw trimming chamber assembly of an embodiment according to FIG. 7A and FIG. 7B in the raised position, showing the components of the outer frame, the inner frame 220, the mesh bottom 250, and assembly tilt support 240.

FIG. 8B is a perspective view of the detail of a corner of an outer frame of FIG. 8A in the horizontal position illustrating the pivoting attachment of the assembly tilt support 240 to an outer frame member 214.

FIG. 9A is a perspective view of a claw trimming chamber assembly of an embodiment according to FIG. 7A and FIG. 7B showing the positioning panel 150 open.

FIG. 9B is a perspective view of a claw trimming chamber of FIG. 9A detached from base 200 and folded.

FIG. 10A is a perspective view of a claw trimming chamber assembly of an embodiment according to FIG. 7A and FIG. 7B in a raised position.

FIG. 10B is a side view of the claw trimming chamber assembly of FIG. 10A.

FIG. 11 is an exploded perspective view of a claw trimming chamber assembly of an embodiment according to FIG. 7A and FIG. 7B illustrating the relationship of the claw trimming chamber 100, the inner frame 220 and the outer frame 210.

### DESCRIPTION OF PREFERRED EMBODIMENTS

In general, the claw trimming chamber assembly is sized to accommodate the size range of a particular animal or suitable animals. In preferred embodiments, the length of the claw trimming chamber assembly is sized to the length of the animal in a relaxed prone position. In preferred embodiments, the width of the claw trimming chamber assembly is narrow enough to discourage the animal from turning around. In preferred embodiments, the height of the claw trimming chamber assembly is sized to be low enough to encourage the animal to rest in a prone position with the bottom of its feet applied to the chamber mesh floor when the chamber is in the horizontal position. In certain embodiments, at least one of the dimensions of length, width and height of the chamber that contains the animal is adjustable.

In use, one end of the chamber is raised to move the chamber from an horizontal position and is secured in a raised position that provides convenient access to the underside of the chamber mesh floor. As the end of the chamber is raised, the animal naturally extends its claws through the chamber mesh floor to maintain its position. The animal's claws remain extended through the chamber mesh floor when the chamber is secured with the end in the raised position, and the tips of the animal's claws can be trimmed with minimal likelihood of distress or injury. The gauge of the mesh is chosen depending on the size of the animal to provide the required strength and appropriate spacing for the animal's claws and paws or feet.

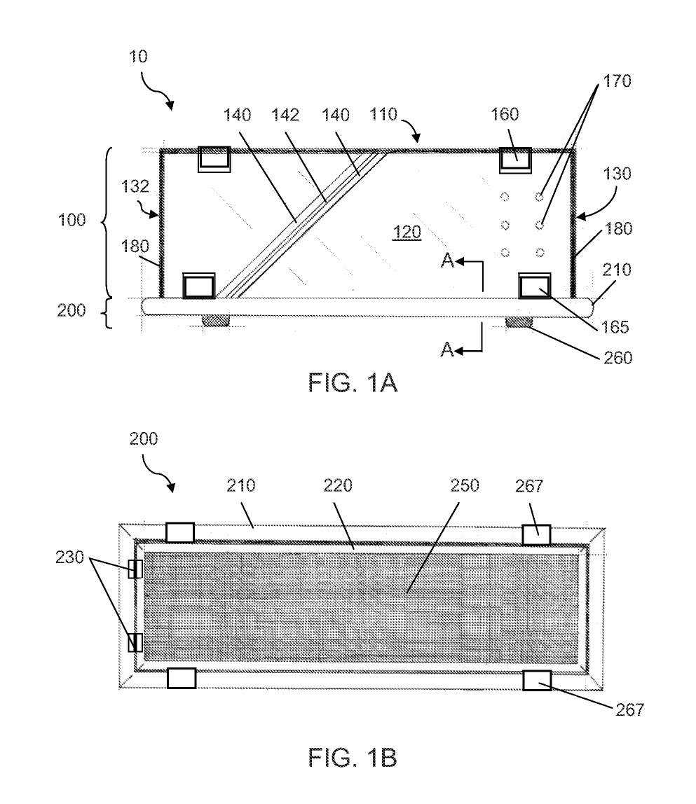

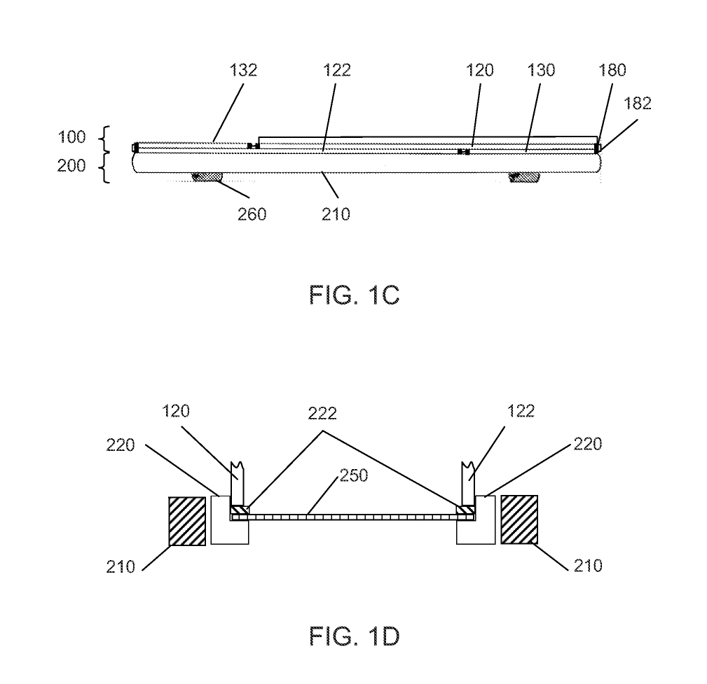

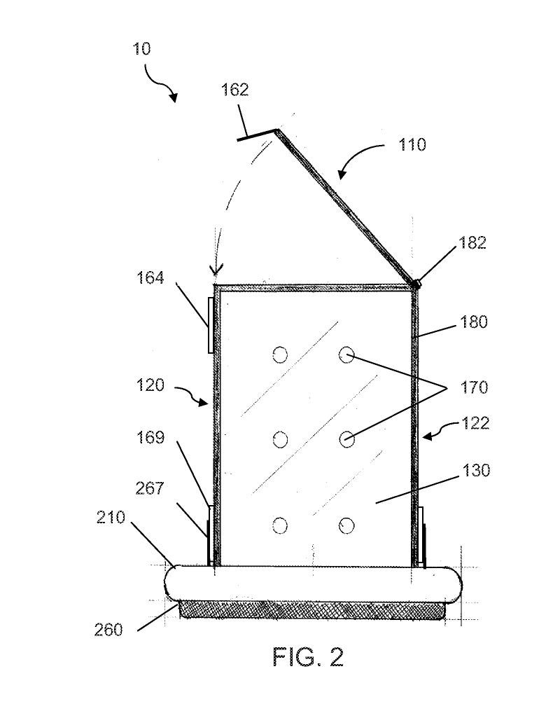

FIG. 1A to FIG. 11, taken together, illustrate several embodiments of a claw trimming chamber assembly. FIG. 1A shows a side view of an embodiment of a claw trimming chamber assembly 10 comprising a claw trimming chamber 100 and a base 200. In one embodiment, the outline of chamber 100 is rectangular in top, side and end views. The claw trimming chamber 100 comprises a top panel 110, a first side panel 120, a second side panel 122, a first end panel 130 and a second end panel 132, each having an inner surface and an outer surface. Ventilation holes 170 are provided in at least one, preferably all, of top panel 110, first side panel 120, second side panel 122, first end panel 130 and second end panel 132. The floor of the chamber is formed by the chamber mesh floor 250 of the inner frame 220 of base 200.

In preferred embodiments, top panel 110 is attached by at least one chamber hinge 182 to either the first side panel 120 or the second side panel 122, and is secured to the opposite side panel and/or at least one end panel by at least one top latch 160. In other embodiments, top panel 110 is attached by at least one chamber hinge 182 to either the first end panel 130 or the second end panel 132, and is secured to the opposite end panel and/or at least one side panel by at least one top latch 160. Chamber hinge 182 may be any suitable hinge such as a pin hinge, or a living hinge comprising a flexible material, such as a polymer, a fabric, or a composite material. In certain embodiments, chamber hinge 182 comprises a polymer living hinge made of the same translucent or transparent polymer that is used to construct the sides and the end panels of the chamber.

In further embodiments, the top may be a panel that slides in tracks formed in the upper edge of the first side and the second side. In yet further embodiments, the top may be a flexible panel of woven fabric, non-woven fabric or polymer sheet that is secured to the upper edges of the first side, second side, first end and second end.

In certain embodiments, top latch 160 comprises a side portion 164 affixed to the inner surface, outer surface or edge of the side opposite the side that is attached the hinge and a corresponding top portion 162 that is affixed to the inner surface, outer surface or edge of top 110. In certain embodiments, top latch 160 may be a magnetic latch or a mechanical latch such as a hook and eye latch, a snap latch or a hook and loop latch.

The inner surfaces of the first side panel 120 and the second side panel 122 of the chamber 100 have a multiplicity of guides 140 that define at least one channel 142. In preferred embodiments, a removable positioning panel 150 is placed in channel 140 to bear some of the animal's weight when the chamber is elevated to the raised position, thereby reducing the weight borne by the claws and increasing the animal's comfort.

FIG. 1D shows an embodiment of a claw trimming chamber and base in cross section view at the line A-A of FIG. 1A, showing outer frame 210, inner frame 220, retaining frame 222, chamber mesh floor 250, the lower edge of first side panel 120, and the lower edge of second side panel 122.

In certain embodiments, the chamber 100 is disposed on the base 200, and is supported by the inner frame 220. In some embodiments, the chamber 100 is maintained in position on the base 200 at least in part by the fit between the outer surfaces of the lower edges of the first side panel 120, the second side panel 122, the first end panel 130, the second end panel 132, and the inner frame 220. See FIG. 1D.

In other embodiments, the chamber 100 is also affixed to the base 200 by one or more optional base latches 165. A base latch 165 comprises a side portion 169 that is affixed to the inner surface, outer surface or edge of first side panel 120, second side panel 122, first end panel 130 and/or second end panel 132 and a corresponding base portion 267 that is affixed to the inner frame 220. In certain embodiments, base latch 165 may be a magnetic latch or a mechanical latch such as a hook and eye latch, a snap latch or a hook and loop latch. In certain embodiments, the side portion 169 of the bottom latch 165 interacts with the chamber mesh floor 250.

The base 200 comprises an outer frame 210 attached to outer frame legs 260, an inner frame 220, and an assembly tilt support 240. The chamber mesh floor 250 is affixed to the inner frame 220. In certain embodiments, the inner frame 220 pivots on the side of the inner frame that corresponds to the second end 132 of chamber 100. In preferred embodiments, the inner frame 220 and the outer frame 210 are pivotally linked by at least one base hinge 230. Base hinge 230 may be any suitable hinge such as a pin hinge, or a living hinge comprising a flexible material such as a polymer, a fabric, or a composite material.

The first side panel 120 and second side panel 122 are joined to the first end panel 130 and the second end panel 132 at chamber junctions 180. In preferred embodiments, the chamber junction 180 comprises a chamber hinge 182. Chamber hinge 182 may be any suitable hinge such as a pin hinge, or a living hinge comprising a flexible material, such as a polymer, a fabric, or a composite material. In certain embodiments, chamber hinge 182 comprises a polymer living hinge. The chamber 100 may be folded on top of the base 200 for transport or storage as shown in FIG. 1C.

In preferred embodiments, at least one of the top panel 110, first side panel 120, second side panel 122, first end panel 130 and second end panel 132 is constructed of a translucent or transparent material. In certain embodiments, the translucent or transparent material is a polymer sheet. In some embodiments, the same polymer is used to form the top panel 110, first side panel 120, second side panel 122, first end panel 130 and second end panel 132 and a living hinge in the chamber hinges 182. In other embodiments, at least one of the top panel 110, first side panel 120, second side panel 122, first end panel 130 comprises a flexible material such as a woven fabric, a non-woven fabric, a flexible mesh, or a flexible polymer sheet.

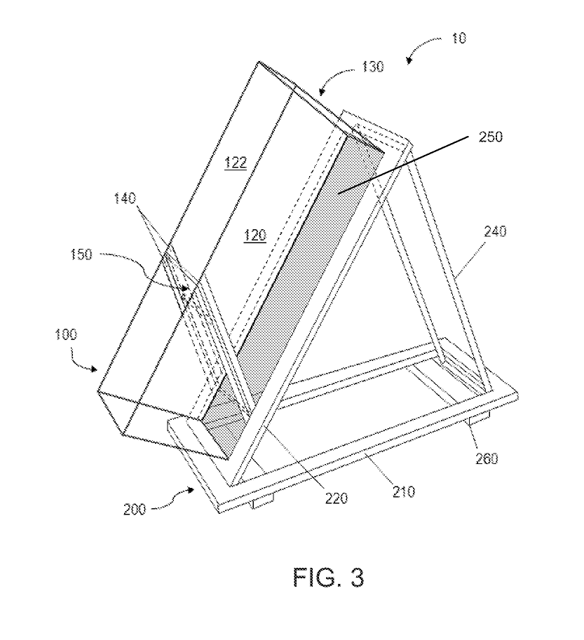

FIG. 3 shows a perspective view of an embodiment of a claw trimming chamber assembly 10 in the raised position, showing chamber 100, base 200, first side panel 120, second side panel 122, first end panel 130, guides 140, removable positioning panel 150, outer frame 210, inner frame 220, an assembly tilt support 240, chamber mesh floor 250, and legs 260. For clarity, top panel 110, top latches 160, optional base latch 165, chamber junctions 180, chamber hinges 182, and base hinges 230 have been omitted from FIG. 3.

The assembly tilt support 240 may comprise a single member or paired members. The assembly tilt support 240 may have a fixed length or be adjustable, e.g., telescoping. In certain embodiments, the assembly tilt support 240 is pivotally linked at its upper end where it contacts inner frame 220. In certain embodiments, the assembly tilt support 240 is pivotally linked at one end where it contacts outer frame 210. In other embodiments, the assembly tilt support 240 comprises two sections that have a hinged joint and are pivotally linked to the inner frame 220 and the outer frame 210 respectively at the ends distal to the hinged joint. In other embodiments, the lower end of the assembly tilt support 240 is pivotally attached to the outer frame leg 260 instead of to the outer frame 210.

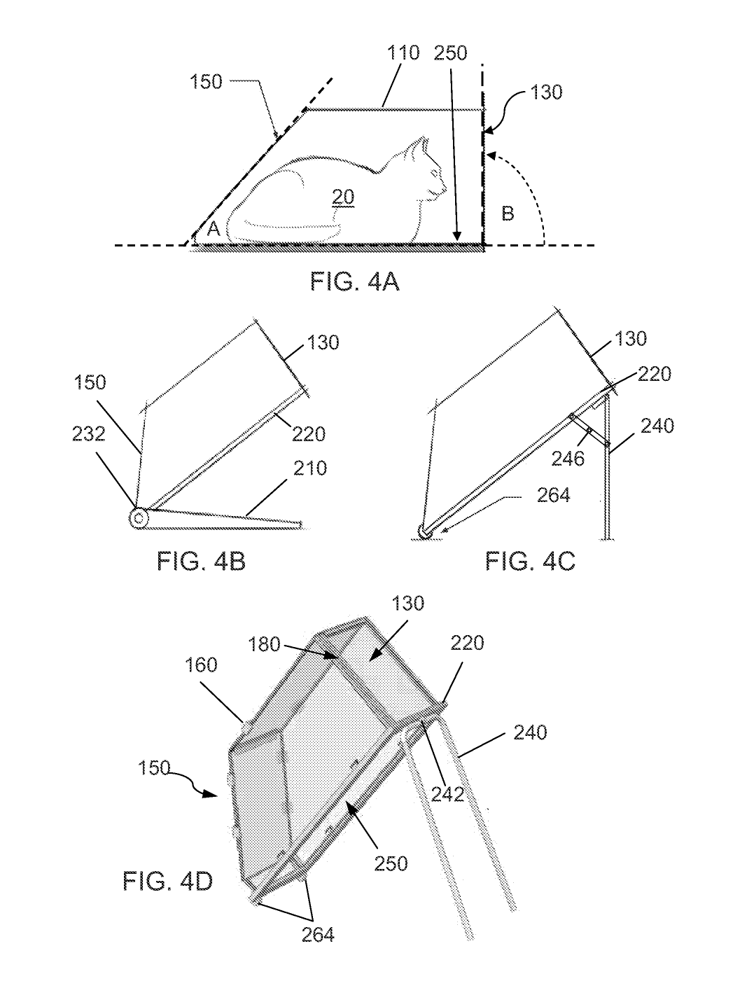

FIG. 4A is a schematic diagram of a side view of an embodiment of a claw trimming chamber in the horizontal position that illustrates common features of the various embodiments. The floor of the chamber is formed by a mesh bottom 250, a top panel 110, a first end panel 130, a positioning panel 150, a first side panel 120 (for clarity, not shown in FIG. 4A; see FIG. 3) and a first side panel 122, also not shown in FIG. 4A. During use, the companion animal 20 faces the first end panel 130. In general, the positioning panel 150 forms an acute (less than 90 degrees) angle A with the plane of the mesh bottom 250, while the first end panel 130 forms an obtuse (90 to 180 degrees) angle B with the plane of the mesh bottom 250.

FIG. 4B is a schematic diagram of a side view of an embodiment of a claw trimming chamber assembly in the raised position, where the claw trimming chamber assembly has an outer frame 210, but lacks an assembly tilt support 240. In such embodiments, the tilt angle is supported by an adjustable locking pivot or locking hinge 232. The outer frame 210 may be a complete rectangle as in the embodiment of FIG. 3, a solid or filled weighted base, or a three-sided base that is open at the side opposite hinge 232.

FIG. 4C is a schematic diagram of a side view of an embodiment of a claw trimming chamber assembly in the raised position, where the claw trimming chamber assembly has an assembly tilt support 240, but lacks an outer frame 210. In such an embodiment, at least two legs 264 are attached to the inner frame 220 instead of to the outer frame 210 as in the embodiment illustrated in FIG. 1A to FIG. 3. In preferred embodiments, legs 264 comprise a material that reduces sliding on a smooth surface. The assembly tilt support 240 is typically pivotably connected to inner frame 220. Optionally, assembly tilt support 240 is also linked to the inner frame 220 by at least one folding brace 246.

FIG. 4D is a perspective view of an embodiment of a claw trimming chamber assembly in the raised position, where the claw trimming chamber assembly has an assembly tilt support 240, but lacks an outer frame 210. The assembly tilt support 240 has two legs that contact the surface on which the claw trimming chamber assembly is placed. In this embodiment, the assembly tilt support 240 is pivotably connected to inner frame 220 at least one pivot adapter 242. Optionally, assembly tilt support 240 may also be linked to the inner frame 220 by at least one folding brace 246, as illustrated in FIG. 4C.

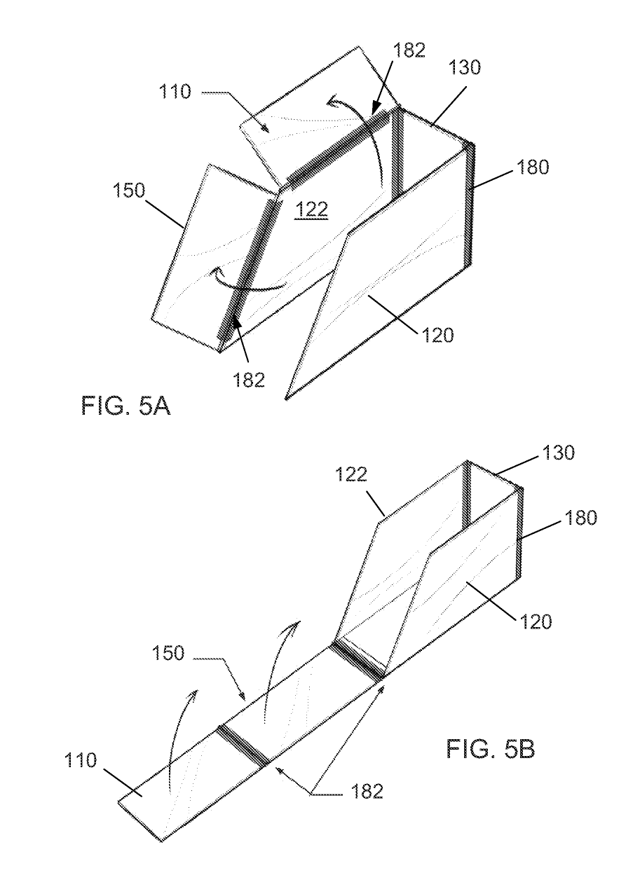

FIG. 5A and FIG. 5B are perspective views of two embodiments of a claw trimming chamber assembly according to FIG. 4A, illustrating the top panel 110 and the positioning panel 150 connected to the chamber using chamber hinges 182. In preferred embodiments, the chamber hinges 182 comprise a polymer living hinge.

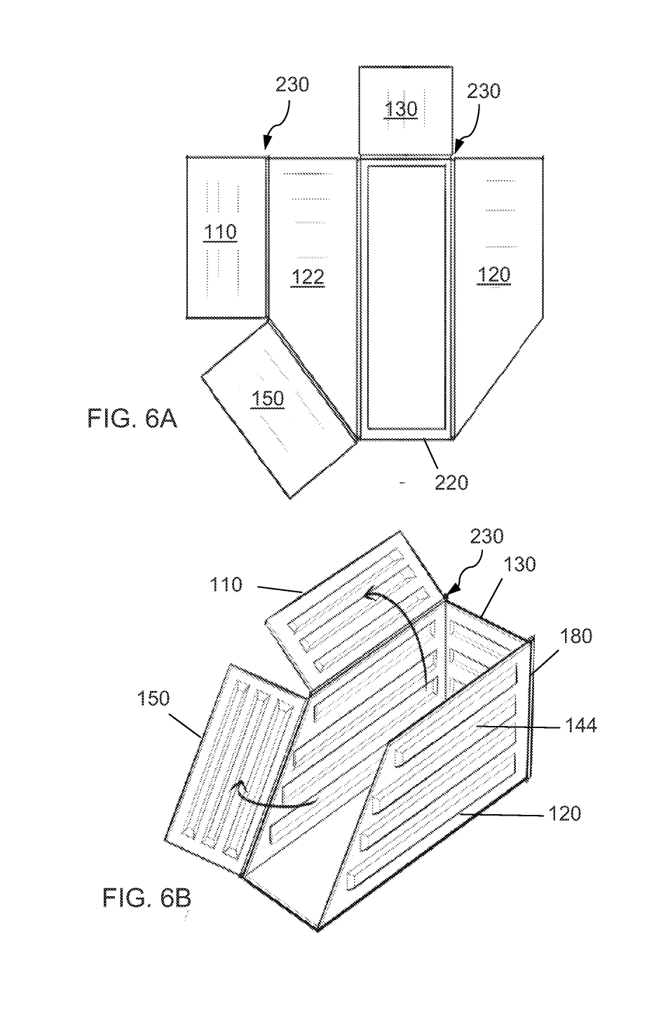

FIG. 6A is a schematic diagram of an embodiment in which the claw trimming chamber and the inner frame 220 are produced in a single flat molded structure that comprises the top panel 110, first end panel 130, first side panel 120, second side panel 122, and the positioning panel 150 connected to one another or to the inner frame 220 by hinges 230. In preferred embodiments, the hinges 230 comprise a polymer living hinge.

FIG. 6B is a perspective view of an embodiment of a molded structure of FIG. 6A having molded ridges 144, and assembled with chamber junctions 180 at the apposed edges of the first end panel 130 and the edges of the first side panel 120 and the second side panel 122.

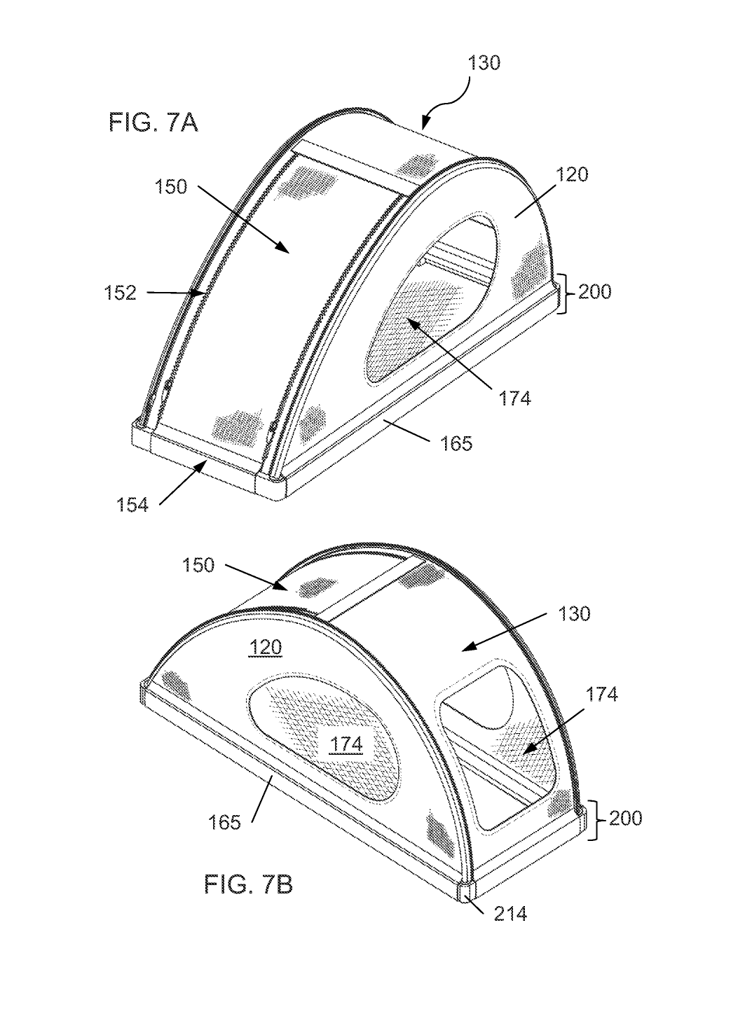

FIG. 7A to FIG. 11 show embodiments of a soft-sided chamber attached to a base 200. The panels of the chamber comprise a woven fabric, a non-woven fabric or polymer sheet that is supported by a panel support member 190 that is itself attached to the outer frame 210. The illustrated embodiments show a one-piece curved panel support member 190. However, one skilled in the art recognizes that the panel support member can be made to provide soft-sided panels of other geometries, such as a rectangular or triangular profile.

FIG. 7A and FIG. 7B are perspective views of an embodiment of a claw trimming chamber according to FIG. 4A having soft side and end panels, and mounted on a base 200 to form a claw trimming chamber assembly. Due to the curved shape of the panel support member 190, the first end panel 130 is continuous with the positioning panel 150. The positioning panel 150 is attached at its top to the first end panel 130, and has lateral closures 152 and a base latch portion 154. In preferred embodiments, the lateral closures 152 comprise hook and loop closures or zippers. In preferred embodiments, the base latch portion 154 comprises a hook and loop closure.

In preferred embodiments, a ventilation panel 174 comprising mesh is provided in at least one of the first end panel 130, the first side panel 120, the second side panel 122 or the positioning panel 150.

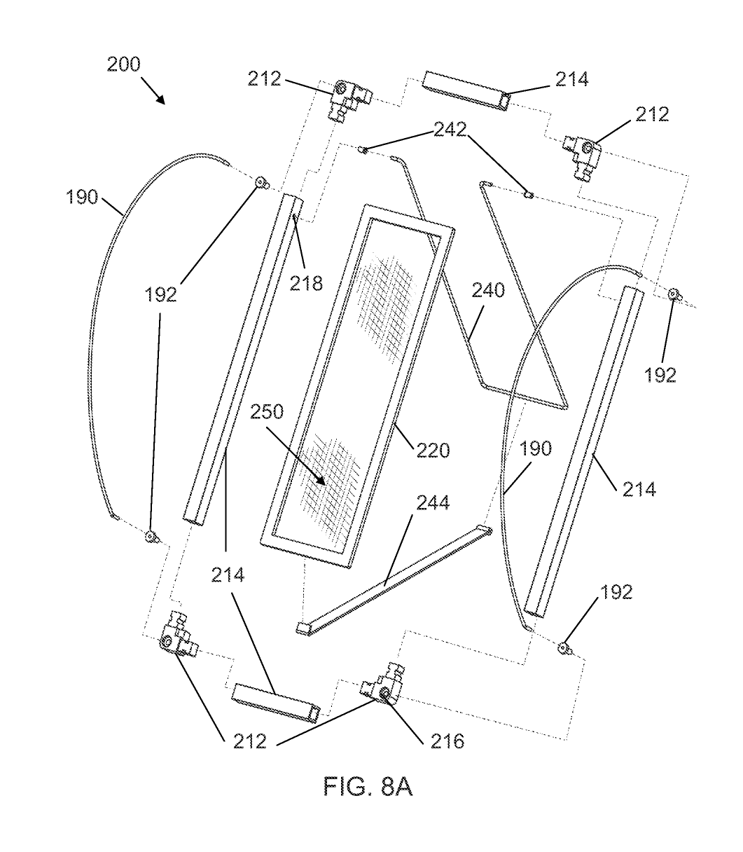

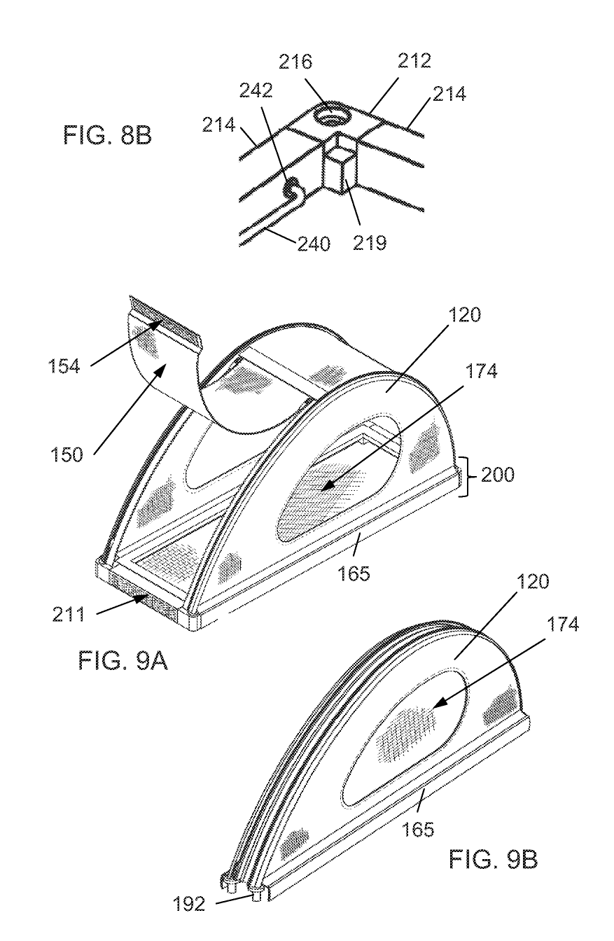

FIG. 8A is an exploded perspective view of the base of a claw trimming chamber assembly of an embodiment according to FIG. 7A and FIG. 7B in the raised position, showing the components of the outer frame, the inner frame 220, the mesh bottom 250, and assembly tilt support 240. The outer frame 210 comprises linear outer frame members 214 connected at corner blocks 212. In certain embodiments, the outer frame members 214 are tubes that may be square, rectangular or circular in cross-section. In certain embodiments, the corner blocks 212 define a cylindrical space to receive the end of a panel support member 190. In preferred embodiments, the end of a panel support member 190 is inserted on a panel support adapter 192 which is then inserted in a corresponding receiver 216 defined by the corner block (see FIG. 8B). In preferred embodiments, the panel support adapter 192 comprises a polymer.

The inner frame 220 houses the mesh bottom 250 of the chamber. The inner frame 220 rests on the inner frame support block 219, and optionally, on supporting pins, blocks or ridges at a corresponding height on the wall of the outer frame member 214 opposite the inner frame (not shown).

The assembly tilt support 240 is pivotably connected to the outer frame 210, as shown in FIG. 8A and FIG. 8B. FIG. 8B is a perspective view of the detail of a corner of an outer frame of FIG. 8A in the horizontal position illustrating the pivoting connection of the assembly tilt support 240 to the outer frame member 214. As shown in FIG. 8A and FIG. 8B, in certain embodiments the ends of the assembly tilt support 240 are inserted into pivot adapters 242 that are inserted into openings 218 in the wall of the outer frame members 214. In preferred embodiments, the pivot adapter 242 comprises a polymer. In certain embodiments, a series of openings 218 are provided in the wall of the outer frame members 214 to provided for adjusting the tilt angle of the assembly. The tilt angle may also be adjusted using a tilt angle retainer 244 that is attached to the end of the assembly tilt support 240 opposite to the end that is pivotably connected to the outer frame. One end of the tilt angle retainer 244 is connected to the assembly tilt support 240 and the other end of the tilt angle retainer 244 is connected to the outer frame 210 or the inner frame 220. In certain embodiments, the tilt angle can be adjusted by adjusting the length of the tilt angle retainer 244. In other embodiments, a folding brace 246

FIG. 9A is a perspective view of a claw trimming chamber assembly of an embodiment according to FIG. 7A and FIG. 7B showing the positioning panel 150 open. In preferred embodiments, the positioning panel latch portion 154 and the opposing outer frame latch portion 211 are corresponding components of a hook and loop closure.

FIG. 9B is a perspective view of a claw trimming chamber of FIG. 9A detached from base 200 and folded. The curve of the soft panel support member 192 may be described as an arc of a circle, a segment of an ellipse, or another curve that is conveniently defined by a mathematical equation. With reference to FIG. 4A, the obtuse angle B of the first end panel 130 and the acute angle A of the positioning panel 150 can be approximated in the soft-sided embodiments by having the radius of curvature of the portion the support adapter 192 supporting the first end panel 130 smaller than the radius of curvature of the portion the support adapter 192 supporting the positioning panel 150.

The support adapter 192 can be preformed of a suitable metal, such as aluminum. In other embodiments, the support adapter 192 can be a flexible rod or cylinder of a suitable polymer or a suitable composite, such as fiberglass. If the support adapter 192 is a flexible rod or cylinder, the radius of curvature can be set by the angle of the receiver opening 216 in the outer frame.

The support adapter 192 can be attached the first end panel 130, the first side panel 120, the second side panel 122, and the positioning panel 150 by a continuous or intermittent sleeve, tapes or flaps secured with a closure, or loops, rings or other attachment sites affixed to the panel. The support adapter 192 may be attached to inner surface or the outer surface of the panels; in preferred embodiments, the support adapter 192 is attached to the inner surface of the panels. In preferred embodiments, the attachment of the support adapter 192 is associated with the junction of a side panel with the first end panel 130 and the positioning panel 150.

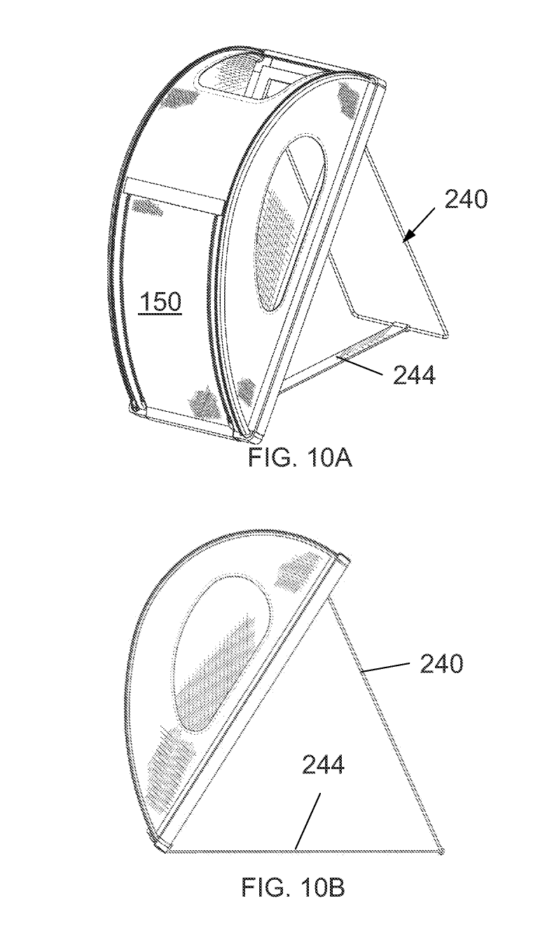

FIG. 10A is a perspective view of a claw trimming chamber assembly of an embodiment according to FIG. 7A and FIG. 8A in a raised position. FIG. 10B is a side view of the claw trimming chamber assembly of FIG. 10A.

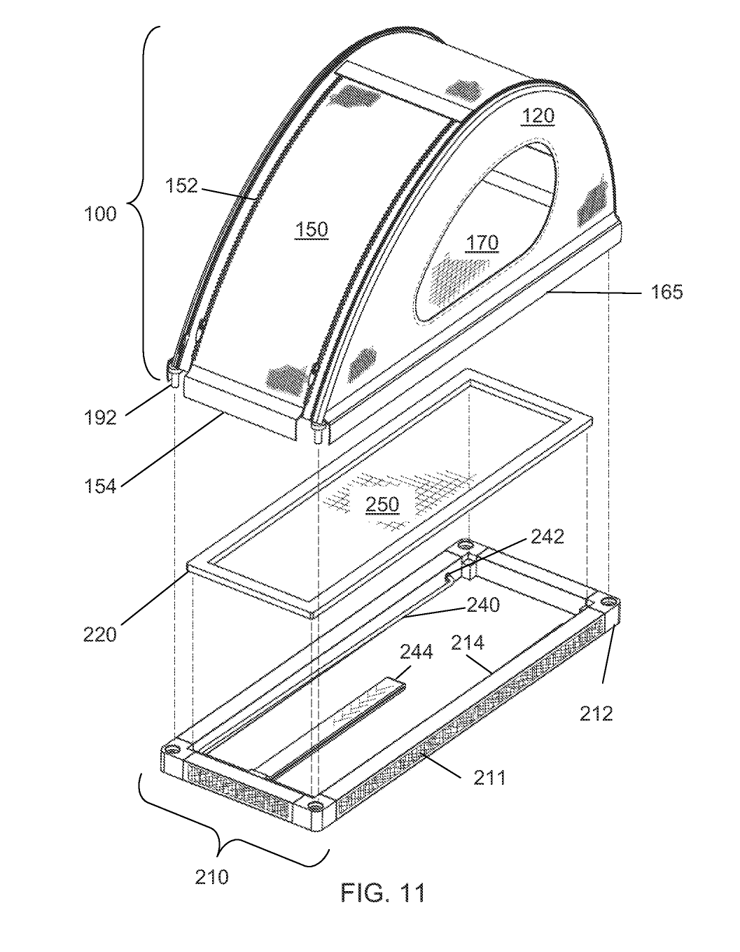

FIG. 11 is an exploded perspective view of a claw trimming chamber assembly of an embodiment according to FIG. 7A and FIG. 8A in the horizontal position, illustrating the relationship of the claw trimming chamber 100, the inner frame 220 and the outer frame 210.

While the foregoing invention has been described in some detail for purposes of clarity and understanding, these particular embodiments are to be considered as illustrative and not restrictive. It will be appreciated by one skilled in the art from a reading of this disclosure that various changes in form and detail can be made without departing from the true scope of the invention, which is to be defined by the appended claims rather than by the specific embodiments.

Unless otherwise defined, all technical and scientific terms used herein have the same meaning as commonly understood by one of ordinary skill in the art to which this invention belongs. In the case of inconsistencies, the present disclosure, including definitions, will control.

What is claimed is:

1. A chamber assembly comprising:
a chamber having a first end and a second end opposite to the first end, a first end panel at the first end, a first side panel, a second side panel, and a positioning panel opposite the first end panel; wherein the first side panel is attached to the first end panel and to the positioning panel, and the second side panel is attached to the first end panel and to the positioning panel, and
a base having an inner frame attached to a chamber mesh floor, the chamber mesh floor having an upper surface and a lower surface, and an assembly tilt support or a locking hinge.

2. The chamber assembly of claim 1, wherein the base further comprises an outer frame.

3. The chamber assembly of claim 2, wherein the base further comprises base hinges that pivotally connect the outer frame and the inner frame.

4. The chamber assembly of claim 1, further comprising a top panel.

5. The chamber assembly of claim 4, wherein the top panel is secured to at least one side by at least one hinge.

6. The chamber assembly of claim 4, wherein the top panel is secured to at least one side by at least one latch.

7. The chamber assembly of claim 1, wherein the chamber is secured to the inner frame by at least one latch.

8. The chamber assembly of claim 2, wherein the chamber is secured to the outer frame by at least one latch.

9. The chamber assembly of claim 1, wherein the inner frame is pivotally linked to the assembly tilt support.

10. The chamber assembly of claim 2, wherein the outer frame is pivotally linked to the assembly tilt support.

11. The chamber assembly of claim 1, wherein at least one of the first end panel, the first side panel, the second side panel and the positioning panel is flexible.

12. The chamber assembly of claim 11, further comprising at least one panel support member.

13. The chamber assembly of claim 1, wherein the chamber can be folded for transport or storage.

14. A method of trimming the claws of an animal comprising the steps of:
placing the animal in the chamber of claim 1;
orienting the animal with its head toward the first end panel of the chamber and with its feet on upper surface of the chamber mesh floor,
elevating the first end of the chamber above the second end of the chamber, whereby the animal's claws extend through the openings in the chamber mesh floor below the lower surface of the chamber mesh floor;
providing user access to the lower surface of the chamber mesh floor; and
removing a portion of the animal's claws that extends below the lower surface of the chamber mesh floor, thereby trimming the animal's claws.

15. The method of claim 14 wherein the step of providing user access to the lower surface of the chamber mesh floor further includes the step of supporting the first end of the chamber above the second end of the chamber to maintain the chamber mesh floor at a chosen angle with respect to gravity.

16. The method of claim 14 wherein the portion of the animal's claws that extends below the lower surface of the chamber mesh floor is removed with a clipper or a grinding wheel.

17. The method of claim 15 wherein the chosen angle is about 30-75 degrees.
